(19) United States
(12) Patent Application Publication
(10) Pub. No.: US 2026/0143211 A1
(43) Pub. Date: May 21, 2026

(54) SYSTEM FOR CHECKING OBJECTS

(71) Applicants: Govinda KEMPERMANN, Gutach (DE); Josef BAAK, Waldkirch (DE); Jan GERBER, Sexau (DE)

(72) Inventors: Govinda KEMPERMANN, Gutach (DE); Josef BAAK, Waldkirch (DE); Jan GERBER, Sexau (DE)

(73) Assignee: SICK AG, Waldkirch (DE)

(21) Appl. No.: 19/359,621

(22) Filed: Oct. 15, 2025

(30) Foreign Application Priority Data
Nov. 15, 2024 (EP) 24213297.5

(51) Int. Cl. H04N 23/45; G06K 7/10; G06K 7/14; G06V 10/12; G06V 10/764; H04N 7/10; H04N 23/80

(52) U.S. Cl. CPC H04N 23/45; G06K 7/10366; G06K 7/10722; G06K 7/1417; G06V 10/12; G06V 10/764; H04N 7/10; H04N 23/80

(57) ABSTRACT

A system for checking objects is provided. The system includes at least one camera module for capturing an object and an evaluation module. The camera module includes a time-of-flight-based 3D image sensor for generating 3D image data and a 2D camera for generating 2D image data. The camera module is configured to transmit the 3D image data and the 2D image data to the evaluation module, and the evaluation module is configured to classify an object captured by the camera module based on the 3D image data and the 2D image data.

### BACKGROUND

### Field

The invention relates to a system and to a method for checking objects.

### Description of Related Art

The checking of objects is essential in many industrial sectors, such as in logistics or airport luggage control, in order to detect faulty or dangerous objects. Such a check is usually carried out by appropriate personnel. For example, an appropriate specialist at an airport conveyor belt checks the items of luggage running over the conveyor belt in order to identify and sort out items that cannot be conveyed or special luggage.

However, one problem with checking the conveyed objects is that the speed and the reliability of the check depend on the person carrying out the check. Thus, longer downtimes of the conveyor belt than necessary can occur. In addition, faulty or dangerous objects can remain undetected due to human error.

It can thus be regarded as an object of the invention to provide a system and a method for checking objects.

This object is satisfied by the subject of claim 1 and by the subject of claim 15.

### SUMMARY

A first aspect of the invention relates to a system for checking objects, in particular conveyed objects, said system comprising:
at least one camera module for capturing an object and an evaluation module,
wherein the camera module comprises a 3D image sensor, in particular a time-of-flight-based 3D image sensor, for generating 3D image data and a 2D camera for generating 2D image data,
wherein the camera module is configured to transmit the 3D image data and the 2D image data to the evaluation module,
wherein the evaluation module is configured to classify an object captured by the camera module based on the 3D image data and the 2D image data.

The evaluation module can output a control signal based on the classification result, in particular wherein an action, e.g. a safety action, is triggered in response to the control signal. For example, in the case of a conveyor belt inspection, the conveyor belt can be stopped in response to the detection of an object of a certain, e.g. potentially dangerous, class in order to remove the object from the conveyor belt or to enable a more precise inspection of the object by appropriate personnel. Thus, the evaluation module can also be configured as a control and evaluation module.

According to the invention, the check of the objects thus takes place by a system provided for this purpose, in particular automatically. In this respect, the system can in particular be configured such that no human intervention is necessary and the recognition, classification and/or an action indicated by the control signal takes place completely automatically. A particular advantage of the invention is that the capture of the objects takes place by means of a compact camera that combines both a 3D image sensor and a 2D camera in a single component, the camera module. In principle, the 3D image sensor and the 2D camera can be accommodated in different housings, but preferably the 3D image sensor and the 2D camera are accommodated in the same housing. Consequently, the installation space required by the camera module can be kept small. In many cases, such as when setting up a corresponding camera in a reading tunnel of a luggage check, the installation space is a decisive factor. Thus, the integration of the camera module can be considerably simplified in particular in regions that are difficult to access. The system can in particular only contain one camera module in order to reduce the required installation space.

The system is in particular suitable for the use in logistics, for example for the classification of objects in warehouses, or for the use in airports, for example for the classification of conveyed objects, e.g. flight luggage, special luggage and the like, wherein conveyed objects are, for example, objects that are transported via a conveyor belt. Of course, the system according to the invention is not limited to such a use, but can also be used in other areas. In particular, the system can also be used in areas such as CEP (Courier, Express, Parcel), consumer goods transport and/or retail. The classification of the object can in particular comprise classifying the object in terms of weight, size, type, shape, value, position and/or state, in particular in terms of fragility and/or explosiveness. In addition or alternatively, the object can be classified into, in particular only, two classes, wherein one class indicates a state that is “OK” or “conveyable” and the other class indicates a state that is “not OK” or “not conveyable”.

A further advantage of the invention is that the system is compatible with existing systems due to its simplicity and can thereby be easily integrated into existing systems.

The aforementioned 3D image data are to be understood as image data that are generated by the 3D image sensor and that in particular include depth information, i.e., for example, a distance of an object represented in the image data from the 3D image sensor. In particular, the 3D information can already be calculated in the camera module by means of a processing unit of the camera module, e.g. by means of an ASIC (Application-Specific Integrated Circuit) provided for this purpose, such as an ISP (Image Signal Processor). The 3D information in particular enables a precise determination of the dimensions of the object, for example, a determination of the size, shape and orientation of the object. The 3D image sensor in particular comprises a time-of-flight-based image sensor, a 3D stereo camera and/or an SLS image sensor (structured light scanning image sensor).

The 2D image data can be “conventional” image data that represent a conventional photographic two-dimensional image. The 2D image data can, for example, comprise color information, in particular high-resolution 2D RGB information, and/or grayscale information for a large number of image pixels. The grayscale information can be generated, for example, by an IR camera, in particular under active lighting, or by converting the RGB information of an RGB camera into grayscale information. The classification of object properties can take place using, in particular exclusively using, the color information and/or using, in particular exclusively using, the grayscale information. In some cases, the classification of object properties using the color information can be more advantageous, e.g. when segmenting the objects, whereas, in other cases, the classification of object properties using the grayscale information can be more advantageous, for example, when the background has the same color as the object or when classifying material properties of the object, wherein the grayscale information, for example, comprises an IR grayscale image that was recorded with infrared light and that is represented in gray scales.

The 3D image data and/or the 2D image data can in particular be transmitted to the evaluation module in a wireless manner, e.g. via WLAN, 5G, Li-Fi or millimeter wave communication, or in a wired manner via a corresponding connection cable.

The evaluation module can in particular be configured to process the 3D image data and the 2D image data before an object classification. The processing of the 3D image data and the 2D image data in the evaluation module is in particular understood such that the 3D image data and the 2D image data are fused with one another in order, for example, to additionally store the 2D image data with depth information.

Due to its compactness, the system according to the invention is thus easy to install, in particular into existing systems. Furthermore, it can be manufactured particularly cost-effectively due to the small number of components required.

Advantageous further developments of the invention are specified in the description, in the drawings, and in the dependent claims.

According to a first embodiment, the 3D image data and the 2D image data are co-registered. In particular, this is already the case with the generation of the respective image data since the 3D image data and the 2D image data are generated in the same component, i.e. the camera module. In this respect, co-registered in particular means that the 3D image data and 2D image data are brought into a spatial and temporal alignment to enable a precise and consistent representation. In particular, no complex synchronization of the 3D image data and 2D image data is required, as is the case, for example, with image data from different camera modules.

According to one embodiment, a superposed field of view of the 3D image sensor and the 2D camera amounts to at least 50° or at least 60°, preferably at least 75°.

However, the superposed field of view of the 3D image sensor and the 2D camera can also be narrower, for example, the superposed field of view can amount to at least 30° or at least 40°. The field of view of the 3D image sensor and/or the 2D camera can in particular extend in a vertical and/or horizontal direction. The 3D image sensor and the 2D camera can thus capture a wide field of view. Advantageously, a plurality of objects can be captured at the same time. This enables an earlier classification of the respective object so that sufficient time remains in order, after a corresponding classification, to execute an action associated with the control signal in response to the output control signal. A further advantage is that, due to the large field of view, the camera module is easy to install without high accuracy requirements so that in particular the likelihood of an incorrect installation or alignment of the camera module is reduced. The large field of view furthermore allows a capture and a classification of a plurality of objects in the field of view of the camera, in particular at the same time.

According to one embodiment, the 3D image sensor and the 2D camera have substantially the same field of view, an overlapping field of view or mutually adjoining fields of view. The above-mentioned monitored zone can be a partial region of the field of view in each case. The field of view refers to the region that can be mapped in the image data. Preferably, for example, at least 90% of the solid angle of the field of view of the 3D sensor and the 2D camera are identical. The visual axes, i.e. the alignment, of the 3D image sensor and the 2D camera are preferably parallel.

For example, the 2D camera can be operated with a 16:9 ratio in a special 1:1 mode so that its field of view substantially matches the field of view, in particular the square field of view, of the 3D image sensor. Preferably, only the pixels of the 2D camera that correspond to the field of view of the 3D image sensor are controlled and read out. The line delay and/or the amount of data generated and thus the image recording time can hereby be reduced. Even when using rolling shutter methods, shorter image recording times and thus less motion blur can be achieved.

According to one embodiment, the 2D camera comprises a processing unit that is configured to dynamically, in particular automatically, adjust image recording parameters of the 2D camera. The processing unit is, for example, an intelligent chip, e.g. an ISP. In other words, the 2D camera has automatic adjustment functions such as Auto Gain, Auto White Balance, Auto Exposure and the like. The automatic adjustment can in particular take place within limits predefined for the respective application. For example, a maximum duration for the exposure time can be predefined in order to prevent or at least reduce motion blur.

According to one embodiment, the camera module and the evaluation module are connected to one another via only one connection cable. In this case, only a single connection cable is therefore required for the electrical connection (i.e. for the data connection and the energy supply) of the camera module to the evaluation module, which significantly simplifies the connection of the camera module to the evaluation module. The connection of the camera module can thereby be considerably simplified in particular in regions that are difficult to access.

Both the energy supply of the camera module and the transmission of the image data can take place via the only one connection cable. In order to enable such a combination of the transmission via the connection cable, the camera module can be configured in an energy-saving manner and the processing of the image data can be shifted to the evaluation module. Due to the relocation of functionality to the evaluation module, not only energy savings result, but the camera module can also be made smaller and more compact, which is likewise advantageous for the industrial applications mentioned.

Preferably, the energy supply of the camera module takes place by the evaluation module only via the one connection cable. Equally preferably, only the one connection cable is exclusively used to transfer the 2D image data and the 3D image data from the camera module to the evaluation module. It is indeed possible that the camera module and the evaluation module are attached to a common structure. However, the camera module and the evaluation module are attached separately from one another and preferably at different locations at the common structure and the communication and the energy supply, as explained, in particular only take place via the connection cable. Alternatively or additionally, the evaluation module can also be arranged in a fixed position, whereas the camera module can change its position. For example, the camera module can change its position to capture different perspectives of an object. Preferably, however, the camera module is also arranged in a fixed position.

According to one embodiment, the connection cable is configured as a high-speed serial interface, in particular as a Gigabit Multimedia Serial Link (GMSL) or a Flat Panel Display Link. Thus, high data rates of up to 3 Gbit/s, 6 Gbit/s or 12 Gbit/s can be transmitted via the connection cable. In particular, the evaluation module can be suitable for processing the large amounts of data. The connection cable can, for example, be configured as in particular only one coaxial cable via which in particular both the energy supply of the camera and the bidirectional communication can take pace. The transmission and/or processing of the data preferably takes place in real time.

In one embodiment, the evaluation module is configured to transmit operating information to the camera module via the connection cable, with the operating information preferably containing a configuration for the camera module and/or a trigger for triggering image recordings. There is therefore preferably also a return channel between the evaluation module and the camera modules or the camera module, via which return channel the evaluation module can transmit data to the camera module.

The configuration transmitted from the evaluation module to the camera module can, for example, be settings as to which image size the 3D image sensor and/or the 2D camera is to provide, to which color depth the 2D camera is to be set and/or which scanning frequency and/or which depth range is to be used by the 3D image sensor.

Due to the aforementioned trigger, at least one of the cameras, i.e. either the 3D image sensor or the 2D camera, can be caused to record image data and to transmit said data to the evaluation module. By means of the trigger, the evaluation module can therefore control when the 3D image sensor and/or the 2D camera generates/generate image data.

In one embodiment, the camera module is configured to feed the trigger signal directly to one of the 3D image sensor and the 2D camera and to feed the trigger signal to the other of the 3D image sensor and 2D camera with a delay. As described, the trigger signal initiates the image recording, i.e. ultimately the generation of the 3D image data and/or the 2D image data. The trigger signal can originate from the evaluation module so that the image generation can be linked to external events, for example. In particular, the trigger signal can be generated at regular, in particular constant, intervals. The generation of the trigger signal is in this respect generally also possible by means of the camera module.

For example, the 3D image sensor can receive the trigger signal directly or without delay and can thus start the generation of 3D image data without delay. The 2D camera can then only start generating the 2D image data with a delay, in particular by a predetermined delay period. Due to the delay, the data transmission via the connection cable can be improved, as explained below.

Alternatively, it is also possible for the 3D image sensor and the 2D camera to receive the trigger signal at the same time, whereby a simultaneous image recording then takes place and the generation of the 3D image data and the 2D image data is simultaneously started.

In one embodiment, a delay unit is provided in the camera module and delays the trigger signal for the 3D image sensor or the 2D camera. In this respect, the delay of the trigger signal caused by the delay unit is selected such that the image data generated without delay have already been transmitted at least partly (or completely) via the connection cable to the evaluation module. This means, for example, that the 3D image data of the 3D image sensor are generated directly without a delay and are also transmitted directly via the connection cable to the evaluation module. The 2D camera only receives the trigger signal and starts generating the 2D image data once the 3D image data have been at least partly or completely transmitted. In this respect, the advantage results that the transmission capacity of the connection cable can be fully utilized for the 2D image data, for example, in the case of an already complete transmission of the 3D image data. The transmission via the connection cable is thus simplified. The advantage also results that no buffer memory (or only a smaller buffer memory) has to be provided in the camera module, e.g. for the usually very large data volume of the 2D image data, whereby the camera module can in turn be configured as smaller, more compact and more energy-saving.

It is understood that the 2D camera can also receive the trigger signal without delay, whereas the 3D image sensor then receives the trigger signal with a delay. In this case, the 2D image data are then preferably transmitted first and the 3D image data are only afterwards transmitted via the connection cable.

In particular, the delay that is generated by the delay unit can be set to a fixed or constant value. This is in particular possible if the data rates and the size of the image data that are generated by the 3D image sensor and the 2D camera are known. The data rate at which the transmission is possible via the connection cable can likewise be known, also referred to as the maximum transmission data rate herein.

Alternatively, it is also possible to determine the respective data rates and/or the size of the image data from the current configuration of the camera module and to calculate the delay period during operation.

Further alternatively or additionally, it is also possible that the delay unit can determine whether image data are sent via the connection cable and/or which image data are sent via the connection cable. The delay unit can then be configured to forward the trigger signal (to that camera which has not yet generated any image data) after a predetermined size of the image data and/or after the end of the image data, for example.

In one embodiment, a serializer is provided in the camera modules and/or a deserializer is provided in the evaluation module, wherein the serializer is connected to the 3D image sensor and/or the 2D camera via one data connection in each case, wherein the serializer integrates, i.e., for example, converts, the 3D image data and/or the 2D image data into a serial data stream and transmits said data via the connection cable.

In particular, the deserializer receives the serial data stream via the connection cable and extracts the 3D image data and/or the 2D image data from the serial data stream. In other words, the deserializer reconstructs the 3D image data and/or the 2D image data from the serial data stream.

In particular, the serializer, the deserializer and the connection cable can form a GMSL system (Gigabit Multimedia Serial Link system) or can be based on such a system.

The above-explained delay of the trigger signal can in particular result in the 3D image data and the 2D image data successively arriving at the serializer so that preferably no data congestion occurs at the serializer so that a maximum throughput can be achieved via the connection cable. In addition, it can be ensured that no image data are lost.

Furthermore, it can be ensured by the deliberate delay that the image data (i.e. each image) have a unique and correct time stamp. This can facilitate the correct processing of the image data in the evaluation module. In addition, it can be ensured by the delay that the maximum bandwidth or transmission rate of the connection cable is not exceeded at any point in time.

In one embodiment, the serializer and/or the deserializer is/are configured to transmit the 3D image data and the 2D image data in separate virtual channels via the connection cable. A simplified handling can hereby result that in particular consists of a simplified integration and extraction of the image data into/from the serial data stream. The serializer and/or the deserializer can provide a corresponding protocol that makes the virtual channels possible.

In one embodiment, the 3D image sensor is configured to generate the 3D image data at a first maximum data rate and the 2D camera is configured to generate the 2D image data at a second maximum data rate. In addition, a data transmission via the connection cable is possible at a maximum transmission data rate. In particular, the first data rate and/or the second data rate is/are individually greater than the maximum transmission data rate. Alternatively or additionally, the first and second maximum data rate taken together are greater than the maximum transmission data rate.

The maximum data rate is to be understood as the maximum data rate which the 3D image sensor or 2D camera can achieve, for example, at a maximum resolution, a maximum scanning rate, a maximum color depth, a maximum scanning range, etc. The maximum data rate can be higher than the maximum transmission data rate. Therefore, at least temporarily, more data can be generated by the 3D image sensor or the 2D camera than can be transmitted via the connection cable in one unit of time.

If the first and the second maximum data rate are only greater than the maximum transmission data rate when taken together, the aforementioned delay, which leads to a successive transmission, can already be sufficient in order not to exceed the maximum transmission data rate. If the first and/or second maximum data rate alone is also greater than the maximum transmission data rate, additional measures can also be taken as described below.

In one embodiment, the 2D camera is configured to generate image data only for a part of its field of view. The 2D camera can therefore be configured to perform a so-called “cropping”. Preferably, the 2D camera supports the cropping natively, i.e. only part of its image sensor is read out, for example. Due to such a cropping already at the level of the image sensor, an energy saving can take place since no unnecessary data are generated. In addition, a saving of transmission bandwidth can take place. Furthermore, it is possible to read out different parts of the image sensor one after another, i.e. to display different image regions in different images. For example, the image region to be read out can be changed after a respective trigger signal so that the evaluation module is then put into a position to reconstruct an overall image of the monitored zone from the 2D image data.

In one embodiment, a buffer memory for 3D image data that is connected to the 3D sensor is provided in the camera modules, wherein the camera module is configured to write the 3D image data to the buffer memory at a higher data rate than the buffer memory transfers the 3D image data to the serializer and/or to the evaluation module. The 3D sensor usually delivers a very large amount of data in a very short time, so-called bursts. This maximum data rate of the 3D sensor can significantly exceed the maximum transmission data rate. The data rate can then be reduced via the buffer memory, i.e. the transmission of the 3D image data via the connection cable is preferably stretched out over time.

In particular, the 3D image sensor can output the 3D image data via a MIPI interface, in particular to the buffer memory. A slowed-down output of the 3D image data from the buffer memory can then take place.

The buffer memory can in particular be part of a processor, for example a signal processor, in particular a digital signal processor, DSP. Further in particular, the processor performs a modification of the 3D image data, for example, a compression and/or an extraction of the depth information. The depth information can then at least partly or completely replace the previous 3D image data, with the 3D image data modified and/or replaced in this way being transmitted via the connection cable.

For example, the 3D image sensor comprises an integrated processing device, e.g. a DSP, that calculates the depth information from 3D raw data (measured phase information of the emitted and subsequently backscattered light). The 3D raw data can (initially) be the 3D image data. The processing device can furthermore filter out invalid pixel information based on changeable criteria and can perform preprocessing steps (before the conversion into depth information) and postprocessing steps that can in particular be parameterized by the evaluation module. The processing device can add status information about the pixel data (e.g. metadata, confidence data) to the 3D image data.

By calculating the depth data from the 3D raw data, the amount of data can be significantly reduced, for example, by a factor of 9. The transmission of the 3D image data via the connection cable can thereby be simplified.

The statements regarding the buffer memory and/or the processor also apply accordingly to the 2D image data that can likewise be output at a slower rate by a corresponding buffer memory. In both cases, the size of the buffer memory can be dimensioned such that the buffer memory never fills up.

Preferably, however, the 2D image data are transmitted via the connection cable in an unchanged manner and/or in particular not delayed by a buffer memory provided for a delay.

With the exception of the compression of the 3D image data, preferably no change of the image data can take place in the camera module, whereby the camera module can again be made more compact and energy-saving. Preferably, no change to the image data takes place in the camera module at all that has effects on the information content of the 3D and/or 2D image data (the conversion by means of the serializer does not change the information content of the image data).

In particular, the delay device can, for example, also be integrated into the processor so that the processor also generates the delay.

In one embodiment, the 3D image data and the 2D image data have different formats and/or different sizes, wherein the 3D image data and/or the 2D image data are preferably present in a data format that occupies whole bytes in each case. The transmission of the different data formats creates an additional complexity that is taken into account by the aforementioned measures of the virtual channels and of the transmission taking place successively. By using data formats that use whole bytes in each case, for example RAW16 or RAW8, the bandwidth in the connection cable can be fully utilized.

In one embodiment, the camera module comprises an energy store, in particular a capacitor bank, that is configured to store electrical energy obtained via the connection cable and to output the stored electrical energy in the case of an energy demand of the camera module that exceeds the electrical power transmitted via the connection cable, wherein the energy store preferably has a limiting circuit that limits a speed at which the energy store is charged.

The energy transmission via the connection cable is limited, wherein the camera module can in particular require more electrical power during the image recording than can be provided via the connection cable. In such a case, the additional energy required can then be briefly drawn from the energy store. Once the image recording is complete, the energy store can then be recharged to be able to then provide electrical energy during the next image recording.

The limiting circuit prevents an overloading of the connection cable. The limiting circuit can be configured to enable the charging of the energy store, for example, with a constant or permanently set maximum value of a charging current. Alternatively or additionally, the limiting circuit can comprise a sensor system that compares the current energy consumption of the camera module with the maximum possible energy amount that can be supplied by the connection cable, and that uses the difference to charge the energy store (the charging current is then set accordingly). In this way, an optimum utilization of the energy transmission via the connection cable can be achieved.

Preferably, the camera module is configured such that the averaged energy consumption of the camera module is less than the maximum energy amount that can be supplied via the connection cable. The averaged energy consumption can, for example, be determined over several minutes during a regular operation of the system. In particular, the averaged energy consumption amounts to at least 60%, in particular at least 70%, further in particular at least 80%, of the maximum energy amount that can be supplied via the connection cable. On the other hand, the averaged energy consumption, however, amounts to a maximum of 80%, in particular a maximum of 90%, in particular a maximum of 95% of the maximum energy amount that can be transmitted via the connection cable. On average, the energy consumption may not exceed the maximum energy amount that can be supplied via the connection cable since otherwise no energy reserves are left to recharge the energy store.

For this reason, the camera module is to be operated in as energy-saving a manner as possible. For example, it can be provided that the 2D camera performs a pixel binning and/or the 3D sensor performs a reduction of the transmission power for an emitted optical signal (i.e. the transmission light), in particular if the monitored zone of the 3D sensor is reduced. Further energy-saving measures are naturally likewise possible.

To transmit the electrical energy via the connection cable, a respective separating filter can be provided in the camera module and/or in the evaluation module in order to separate the data transmitted via the connection cable, i.e. the image data, from a signal of the energy supply. For example, the data can be filtered out by means of a high-pass filter, whereas the energy supply can take place via a low-pass filter.

In one embodiment, the connection cable is a coaxial cable or a cable with a single shielded twisted pair line. The coaxial cable can, in particular with respect to the components that are electrically connected to both the camera module and the evaluation module, only have a shield and a center conductor. In the same way, the twisted pair line can likewise have only two conductors and possibly a shield. Only the center conductor and the shield or only the twisted pair lines and their shield are preferably used for the data transmission and/or the energy transmission, otherwise no additional electrical connections are used.

Preferably, the ground or the shield is connected to the housing of the camera module and/or of the evaluation module directly or with low impedance. The ground or shield can in this respect be connected to a protective conductor connection (PE connection). In this way, the EMC compatibility of the system can be increased.

As already indicated above, the camera module and the evaluation module are arranged separately from one another and are preferably formed in separate housings. The connection cable can have a minimum length of 0.5, 1 or 2 m, for example. The connection cable can, for example, have a maximum length of 15 m, 20 m or 30 m. The evaluation module and the camera module preferably each have a plug-in option, for example at their housing, for a plug connector of the connection cable. The connection cable can therefore in particular have two plug connectors, one for the camera module and one for the evaluation module. The plug connectors can be releasably attached at the plug-in options.

In one embodiment, the 3D image sensor is a TOF sensor (Time of Flight Sensor) or an iTOF sensor (indirect Time of Flight Sensor), in particular a laser scanner or a LIDAR (Light Detection and Ranging). The 3D image sensor can in particular have a transmission light source that emits transmission light in a monitored zone. In the monitored zone, the transmission light can be incident on objects that remit, i.e. reflect, the transmission light towards the 3D image sensor. Reflected transmission light detected by the 3D image sensor can then be used to evaluate the time of flight (directly or indirectly) in order to determine the distance from the object. The transmission light can in this respect be emitted into different regions of the monitored zone in order thus to generate a depth image of the monitored zone with a large number of pixels.

In one embodiment, the 2D camera is a monochrome camera or a color camera and preferably at least has a resolution of 4 megapixels, 8 megapixels or 12 megapixels. The 2D camera can in particular have an optics with an image sensor disposed behind it. Due to the optics, an image of the monitored zone is projected onto the image sensor. The image sensor can have the aforementioned resolution of at least 4 megapixels, 8 megapixels or 12 megapixels and can, for example, be configured as a CCD or CMOS sensor.

According to one embodiment, the system comprises a plurality of camera modules that are preferably connected to the evaluation module via, in particular only, one (single) respective connection cable. Preferably, the camera modules are arranged at different positions to provide different perspectives of the object. The evaluation module can be configured to at least partly combine or fuse the 3D image data and the 2D image data of the respective camera modules and to classify the detected object based on the combined data. Based on the 3D image data and 2D image data of the respective camera modules, a multi-perspective overall image of the environment and/or the object can thus be captured and in particular a more precise or more complete image of reality can thus be provided. Preferably, 2, 3, 4 or 5 camera modules are used.

Furthermore, it is also possible that the evaluation module does not carry out a classification on the basis of the combined information, but carries out a respective classification based on the 3D image data and/or the 2D image data of a respective camera module. In this case, the system is redundant since separate classifications are carried out for the image data of the different camera modules.

The classification on the basis of the 3D image data and/or 2D image data of a respective camera module can further be verified by the classification on the basis of the 3D image data and/or 2D image data of at least one other camera module. A classification can, for example, be considered as valid if (at least more than) 50%, more than 60% or more than 70% of the available camera modules provide the same classification result.

The system can thus be adapted and/or extended depending on the application and requirements so that a flexible use is possible. By combining, in particular high-resolution, multi-view 2D and 3D image data, a high degree of accuracy of the classification can be achieved since different perspectives can be captured in detail. This enables a reliable detection and/or classification of the objects since even small objects or anomalies can be precisely recognized. In particular, the evaluation module can reduce the collected image data, i.e. the 2D and/or 3D image data, of the camera modules to essential information for a further processing, in particular for a classification of the object.

It is also possible that the evaluation module is configured as a distributed module so that each of the camera modules is connected to an associated sub-module of the evaluation module. One of the sub-modules can then act as a central evaluation module or as a master module in order to combine the respective data of the individual sub-modules, in particular to synchronize them.

In one embodiment, the evaluation module is configured to perform a temporal synchronization of the respective 2D image data and/or the respective 3D image data of the camera modules. The evaluation module can thus be configured as a central control and evaluation unit. In particular, the recordings of the individual camera modules, i.e. the 2D and/or 3D image data at a respective point in time, that are used for a classification of the object can be coordinated in time, in particular have the same time stamp.

According to one embodiment, a trigger for generating the 2D image data and/or a trigger for generating the 3D image data of the respective camera modules is/are initiated at predefined time intervals. The trigger for generating the 2D image data is, for example, a signal for triggering the image recording of the 2D camera. The trigger for generating the 3D image data is, for example, the emission of a light pulse or a pulse pattern. The trigger can in particular be initiated by the evaluation module. During a 3D image recording, i.e. during the generation of the 3D image data, by a respective 3D image sensor, the emitted pulses and/or pulse patterns of the illumination can interfere with one another, e.g. due to interference between the camera modules or the image sensors of the camera modules. To prevent such an interference, the individual image recordings of the different camera modules can take place offset in time, in particular with a delay of 1% to 5% of the exposure time. With an exposure time of 10 ms, the delay can, for example, be 0.1 ms to 0.5 ms, preferably 0.3 ms. The individual camera modules can therefore be at least minimally desynchronized in terms of time. In particular, respective different pulse patterns can also be used for the different camera modules, wherein a pulse pattern can have a duration of 10 ms, for example. However, delays by 10 to 20 ms can also be used, i.e. the delay time can generally also correspond to the exposure time as long as the delay time is less than the time defined by the frame rate for the generation of two consecutive images. At a frame rate of 30 Hz, this time is e.g. approximately 33 ms. It is thus ensured that the images of the individual cameras are still substantially “simultaneous”, with a predefined tolerance that is defined by the delay, and thus an overall 3D snapshot can be generated based on the fused data.

According to one embodiment, the classification of the object takes place using an AI model. The AI model can, for example, be trained or have been trained based on 3D example image data and/or 2D example image data. The example image data, for example, contain image data in 2D and/or 3D which are acquired by a respective camera module and on which an object or a plurality of objects are displayed for classification, with a respective object in particular belonging to one of the target classes to be determined. The target classes can in particular be predefined; they can therefore be labeled data. Additionally or alternatively, the example image data can also comprise data which are fused by the camera modules and with which the AI model is trained. The AI model can further be trained with image data that are based on different illuminations, in particular intensities of illumination, exposure times and/or different environmental light so that the AI model reacts less sensitively to light conditions. The system hereby becomes particularly robust.

The AI model can, for example, be an artificial neural network, in particular an artificial convolutional neural network (CNN). The AI model can, for example, be executed by the evaluation module or by an external computing device connected to the evaluation module and can perform the classification of the object. The target classes available for the classification can, in particular each, reflect one of the above-mentioned properties of the object. Preferably, the target classes can specify the properties such as different sizes, different types and/or shapes, different values and/or states of the object. Additionally or alternatively, the object can be classified by the AI model into, in particular only, two classes, with one class indicating a state that is “OK” or “conveyable” and the other class indicating a state that is “not OK” or “not conveyable”. Further possible target classes and properties of the target classes are specified in the description of the Figures.

Furthermore, the hardware and software can be adapted to and optimized for the use of AI models; in particular, the hardware can be configured to process large amounts of raw data. The hardware can, for example, be configured to process large amounts of raw data of the camera modules, in particular with a processing speed of up to 40 Gbit/s. For this purpose, the hardware can, for example, comprise GPU accelerator chips or computing devices optimized for AI applications. A classification of an object in real time can hereby be made possible, wherein the classification of an object in particular takes less than 1 second, less than 0.5 seconds, preferably less than 0.1 seconds.

According to one embodiment, the classification of the object takes place using 2D image data and 3D image data that were generated at a first point in time and using 2D image data and 3D image data that were generated at at least one point in time other than the first point in time. In other words, the classification of the object takes place using a plurality of 2D image data and 3D image data generated at different points in time.

If the object is moving, for example on a conveyor belt, a plurality of perspectives of the object captured by a camera module are thus used for the classification of the object. The 2D image data and/or 3D image data generated at the different points in time can, for example, be assigned to different positions of the object in space. The object can thus be tracked during a movement, for example along a conveyor belt. This is in particular made possible by the large field of view of the camera module. Furthermore, each camera module can be configured in such a manner to generate 2D image data and/or 3D image data at different consecutive points in time, wherein the respective points in time are preferably substantially identical for all the camera modules. Thus, an overall image or fused image, in particular based on all the data from all the camera modules, can be generated for a respective point in time. Thus, a plurality of perspectives of the object are provided, in particular also at the different points in time. The time interval between the generated image data can in particular be longer than 0.5 s, longer than 1 s or longer than 2 s. Furthermore, the camera module can have an FPS rate (frames per second) of at least 24 fps, at least 30 fps or at least 60 fps, wherein the FPS rate is preferably 30 fps. Furthermore, a spatial tracking of objects across the image field, in particular across all temporally consecutive individual frames, can take place. By means of the spatial tracking, a separation of the objects on the conveyor belt can further be achieved, for example, by determining spatial data associated with a respective object. As soon as the object has reached a specific position, which is, for example, recognized due to the spatial tracking, one or more predefined functions can furthermore be triggered. For example, in the case of a luggage handling system, when the luggage has reached the specific position, a decision can be made based on the classification result as to whether the luggage is sorted out or not. With the help of the consecutive images and, for example, with the aid of visual markers on the conveyor belt and/or on the objects, a speed of the conveyor belt and/or a conveyor belt standstill can furthermore be detected.

According to one embodiment, the evaluation module is configured to use the one of the 3D image data or 2D image data in order to verify the other of the 3D image data or 2D image data. The 3D information, in particular from a plurality of perspectives, enables a precise determination of properties of the object, for example the dimensions, in particular the shape and orientation, of the object. Thus, properties of an object that are, for example, captured in the 2D image data, such as loops or handles on a suitcase, can be verified using the 3D image data. This means that the 3D image data of the one or more camera modules can be jointly used to verify the properties recognized in the 2D image data or vice versa.

A further aspect of the invention relates to a method for checking objects that comprises that:
the 3D image data and the 2D image data are transmitted to an evaluation module by at least one camera module having a 3D image sensor, in particular a time-of-flight-based 3D image sensor, for generating 3D image data and a 2D camera for generating 2D image data, and
an object captured by the camera module is classified by means of the evaluation module based on the 3D image data and the 2D image data.

A Further aspect of the invention relates to a logistics system for checking conveyed objects, comprising:
a system according to any one of the preceding embodiments; and
a conveying unit, in particular for airports, for transporting the conveyed objects.

The conveying unit in particular comprises an apparatus for moving the object, for example, a gripper arm or a transport vehicle that transports the object. The conveying unit preferably comprises a conveyor belt. Items of luggage are, for example, transported on the conveyor belt and must in particular be classified in order to distinguish conveyable objects from non-conveyable objects and, if necessary, to sort out the non-conveyable objects. The one or more camera modules are in particular arranged in a fixed position. The camera module can capture the conveyed object during a transport on the conveying unit. In particular, the system can be configured to detect and classify the conveyed object without stopping the conveying unit. The classification can in particular take place in real time in this respect. Consequently, downtimes of the conveying unit can be minimized and the efficiency of the logistics system can thus be increased. In one embodiment, however, the logistics system can also be configured to stop the conveying unit for a capture of the conveyed object by the camera module, in particular for a short time, to enable better image recordings. The quality of the 3D image data and/or 2D image data can hereby be improved, for example.

According to one embodiment, the logistics system comprises at least one (optical) reader for machine readable codes and/or at least one (radio-based) RFID (Radio Frequency Identification) reader. The reader for machine readable codes and/or the RFID reader is/are in particular connected to the evaluation module. The respective readers are in particular configured to read a corresponding identification unit located on the conveyed object, e.g. a machine code, in particular a barcode and/or a QR code, or an RFID tag. The identification unit, for example, comprises information on the type, size, a destination and/or other properties of the object. The combination of a reader for machine readable codes and/or an RFID reader and a camera module enables a particularly reliable classification of an object. Furthermore, the classification can be restricted based on the readout result of the reader for machine readable codes and/or the RFID reader. In particular, the logistics system can be configured to classify the object into a predefined number of target classes, in particular fewer than 4, fewer than 3, preferably 2 target classes, based on the readout result of the reader for machine readable codes and/or the RFID reader. For example, the reader for machine readable codes and/or the RFID reader can determine a type of object, e.g. whether the object is a suitcase, a wheelchair, etc., while in a next step the system classifies or checks, in particular only, a state of the object. Additionally or alternatively, the readout result of the reader for machine readable codes and/or the RFID reader can be output as a signal in order, for example, to control a (luggage) sorting system following the logistics system.

Preferably, the camera module (or the camera modules) can be arranged in a fixed position such that the objects moved by the conveying unit can be detected. In particular, the same holders to which the reader for machine readable codes and/or the RFID reader is/are fastened can be used for fastening the camera module or the camera modules. In this way, no additional installation space or even an additional logistics system is required to use the camera module.

The statements regarding the system according to the invention apply accordingly to the method; this in particular applies with respect to advantages and embodiments.

It should be noted that any combination of the above embodiments is possible as long as this has not been explicitly ruled out.

### BRIEF DESCRIPTION OF DRAWINGS

The patent or application file contains at least one drawing executed in color. Copies of this patent or patent application publication with color drawing(s) will be provided by the Office upon request and payment of the necessary fee.

The invention will be presented purely by way of example with reference to the drawings in the following. There are shown:

FIG. 1 schematically, a system for checking objects comprising a camera module and an evaluation module;

FIG. 2 an extended system for checking objects comprising three camera modules that are connected to the same evaluation module;

FIG. 3A a 2D image recording of an object captured by a camera module with a segmenting of the object;

FIG. 3B a 2D image recording of another object captured by a camera module with a segmenting of the object;

FIG. 3C a 2D image recording of another object captured by a camera module with a segmenting of the object; and

FIG. 4 a flowchart for illustrating the image processing procedure.

### DETAILED DESCRIPTION

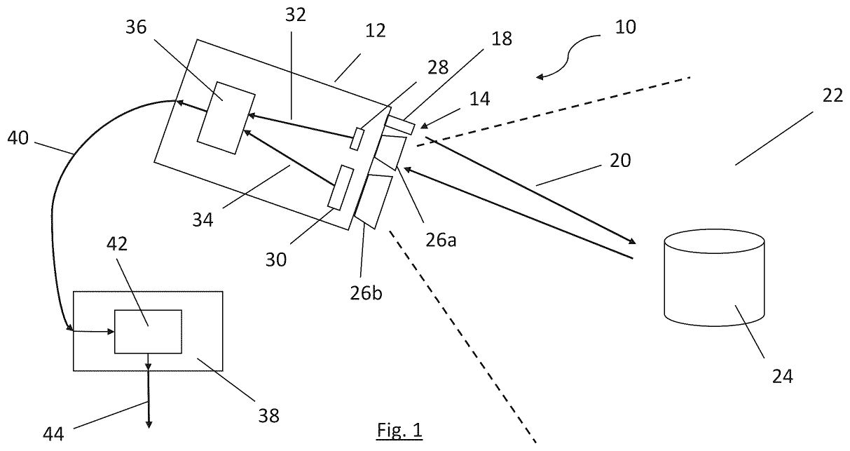

FIG. 1 shows a system 10 for checking objects 24 comprising a camera module 12 (also called a sensor head). The camera module 12 comprises a time-of-flight-based 3D image sensor 14 and a 2D camera 16.

The 3D image sensor 14 comprises a light transmitter 18 that emits transmission light 20 into a monitored zone 22. An object 24 arranged in the monitored zone 22 remits the transmission light 20 that is then directed from the 3D image sensor to an image sensor 28 by means of a lens 26a. The 2D camera 16 likewise comprises a lens 26b and a further image sensor 30.

In this way, the 3D image sensor 14 and the 2D camera 16 generate 3D image data 32 and 2D image data 34 that are transmitted to a serializer 36.

The system 10 further comprises an evaluation module 3 that is connected to the camera module 12 via a single connection cable 40, in particular in the form of a coaxial cable.

The serializer 36 is coupled to the connection cable 40 to transmit the 3D image data 32 and the 2D image data 34 to the evaluation module 38 via the connection cable 40.

A deserializer 42 is provided in the evaluation module 38 and reconstructs the 3D image data 32 and the 2D image data 34 from the data transmitted via the connection cable 40. A processing of the 3D image data 32 and the 2D image data 34 furthermore takes place in the evaluation module 38, wherein the object 24 captured by the camera module 12 is classified based on the 3D image data 32 and the 2D image data 34 and the classification result 44 is output via an interface (not shown) of the evaluation module 38.

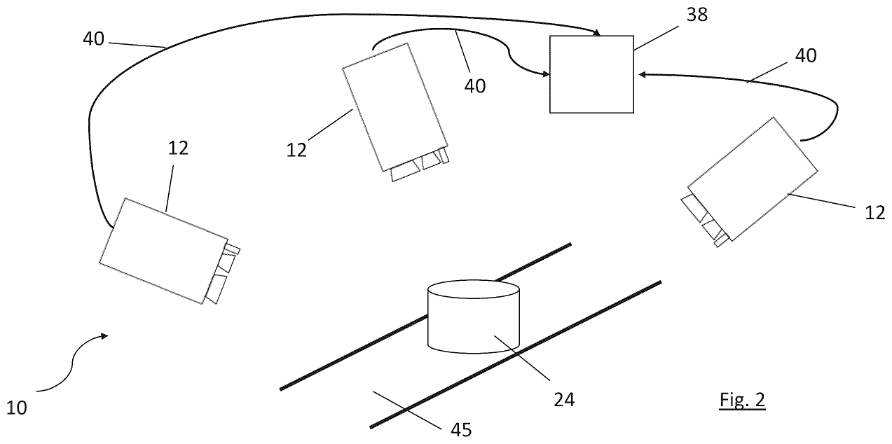

FIG. 2 shows an extended system 10 for checking objects 24 comprising three camera modules 12 that are connected to the same evaluation module 38 via a respective connection cable 40. The camera modules 12 can be configured in accordance with the camera module 12 shown in FIG. 1, wherein, for the purposes of simplification, some of the components of the camera module 12 shown in FIG. 1 are not shown in FIG. 2. The camera modules 12 are arranged at different positions in the space to provide different perspectives of the object 24 that is transported in a conveying direction via a conveyor belt 45. The evaluation module 38 receives the 3D image data 32 and the 2D image data 34 of the respective camera modules 12 and combines them in order to provide as precise as possible a reconstruction of the captured environment, in particular of the captured object 24, and to classify the captured object 24 based on the combined 3D image data and 2D image data.

Due to the combination of multi-perspective 3D image data 32 and 2D image data 34, a high accuracy of the classification can be achieved since different perspectives can be captured in detail.

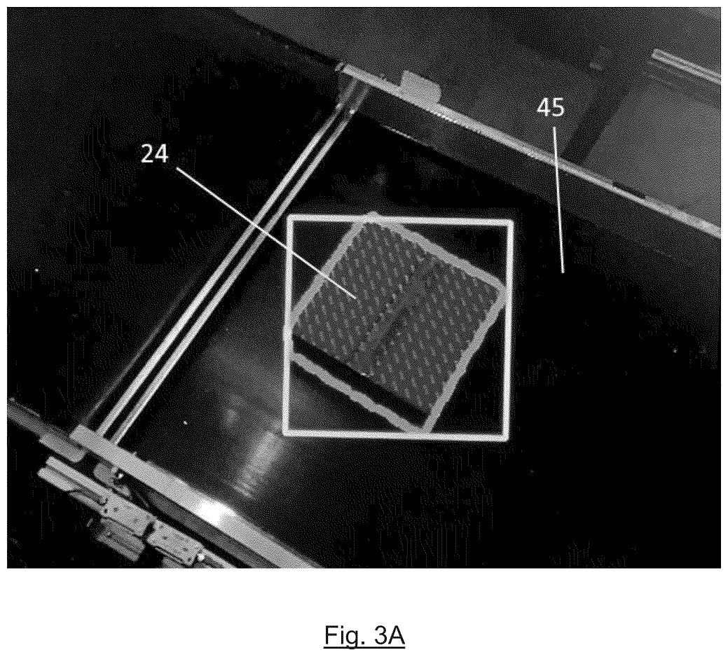

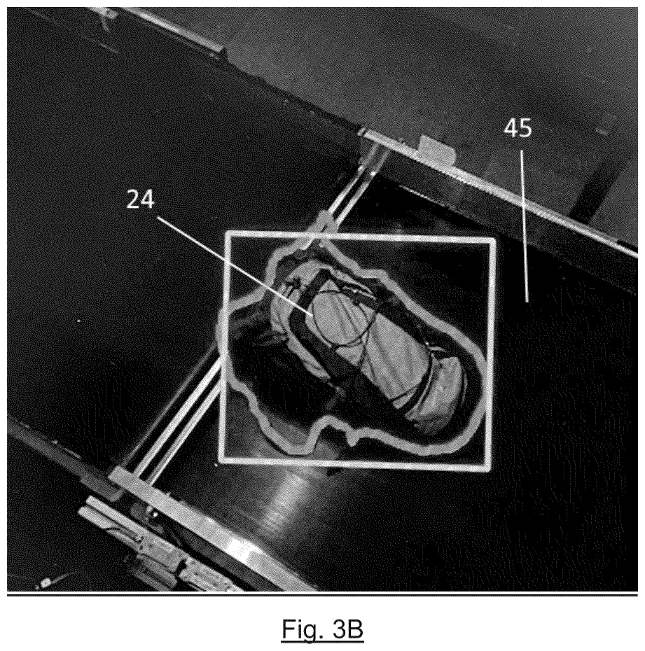

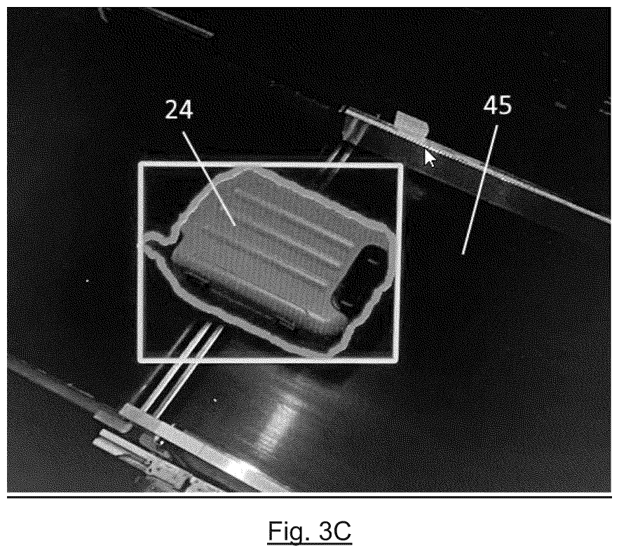

In FIGS. 3A, 3B and 3C, different 2D image recordings of objects 24 captured by a camera module 12, including a segmenting (white outline) of the respective objects 24, are shown. The segmenting can, for example, take place by means of the evaluation module 38. Appropriate image processing methods can be used for this purpose. In the present case, the segmenting of the objects 24 or images was performed by an AI model that is implemented in the evaluation module 38 and that was trained to segment captured objects 24 from the image recordings of the camera module 12, i.e. the generated 3D image data 32 and/or 2D image data 34. In a next step, the segmented object 24 can then be made available to a further AI model that performs a classification of the object 24.

For example, a classification into “non-conveyable” and “conveyable” can take place. In addition, a classification can take place into subclasses that are assigned to the non-conveyable class or the conveyable class. The subclasses can in particular comprise object types. For example, a conventional suitcase can be classified as part of the “suitcase” subclass, wherein the “suitcase” subclass is assigned to the conveyable class. This can take place for the “non-conveyable” class in a corresponding manner. Here, a subclass can comprise “living animals”, for example.

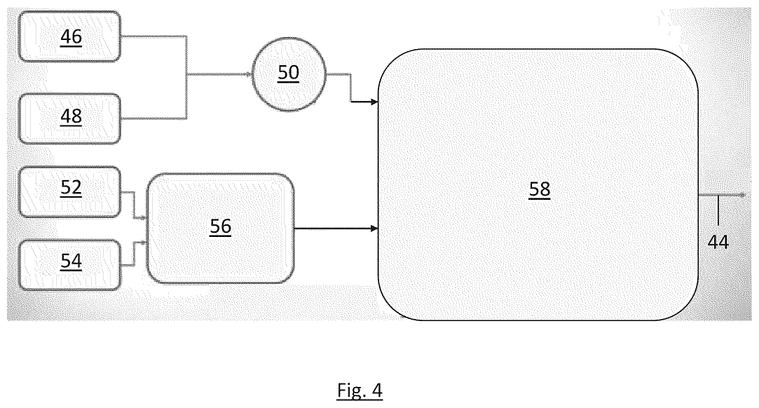

FIG. 4 shows a flowchart for illustrating the image processing procedure. In this respect, 3D image data 46 of a first camera module and 3D image data 48 of a second camera module are merged to form fused 3D image data 50 that are then made available to one or more AI models 58. Furthermore, the 2D image data 52 of the first camera module and the 2D image data 54 of the second camera module are used to perform a segmenting of the image. Subsequently, the segmented image or the segmented 2D image data 56 are also provided to the one or more AI models 58. Using the AI model 58, a class of the object 24 is subsequently determined based on the fused 3D image data 50 and the segmented 2D image data 56.

### REFERENCE NUMERALS LIST

10 system

12 camera module

14 3D image sensor

16 2D camera

18 light transmitter

20 transmission light

22 monitored zone

24 object

26 lens

28 image sensor

30 image sensor

32 3D image data

34 2D image data

36 serializer

38 evaluation module

40 connection cable

42 deserializer

44 classification result

45 conveyor belt

46 3D image data of a first camera module

48 3D image data of a second camera module

50 fused 3D image data

52 2D image data of the first camera module

54 2D image data of the second camera module

56 segmented 2D image data

58 AI model

1. A system for checking objects, said system comprising:
at least one camera module for capturing an object and an evaluation module, wherein the camera module comprises a 3D image sensor for generating 3D image data and a 2D camera for generating 2D image data, wherein the camera module is configured to transmit the 3D image data and the 2D image data to the evaluation module,
wherein the evaluation module is configured to classify an object captured by the camera module based on the 3D image data and the 2D image data.

2. The system according to claim 1,
wherein the objects are conveyed objects.

3. The system according to claim 1,
wherein the 3D image sensor is a time-of-flight-based 3D image sensor.

4. The system according to claim 1,
wherein the 3D image data and the 2D image data are co-registered.

5. The system according to claim 1,
wherein a superposed field of view of the 3D image sensor and the 2D camera amounts to at least 50° or at least 60°.

6. The system according to claim 5,
wherein the superposed field of view of the 3D image sensor and the 2D camera amounts to at least 75°.

7. The system according to claim 1,
wherein the 3D image sensor and the 2D camera have substantially the same field of view, an overlapping field of view or mutually adjoining fields of view.

8. The system according to claim 1,
wherein the 2D camera comprises a processing unit that is configured to dynamically adjust image recording parameters of the 2D camera.

9. The system according to claim 1,
wherein the 2D camera comprises a processing unit that is configured to automatically adjust image recording parameters of the 2D camera.

10. The system according to claim 1,
wherein the camera module and the evaluation module are connected to one another via only one connection cable.

11. The system according to claim 10,
wherein the connection cable is configured as a high-speed serial interface.

12. The system according to claim 11,
wherein the high-speed serial interface is a Gigabit Multimedia Serial Link or a Flat Panel Display Link.

13. The system according to claim 1,
wherein the system comprises a plurality of camera modules.

14. The system according to claim 13,
wherein the plurality of camera modules are connected to the evaluation module via one respective connection cable.

15. The system according to claim 14,
wherein the plurality of camera modules are connected to the evaluation module via only said one respective connection cable.

16. The system according to claim 13,
wherein a trigger for generating the 2D image data and/or a trigger for generating the 3D image data of the respective camera modules is/are initiated at predefined time intervals.

17. The system according to claim 1,
wherein the classification of the object takes place using an AI model.

18. The system according to claim 1,
wherein the classification of the object takes place using 2D image data and 3D image data that were generated at a first point in time and using 2D image data and 3D image data that were generated at at least one point in time other than the first point in time.

19. The system according to claim 1,
wherein the evaluation module is configured to use the one of the 3D image data or 2D image data in order to verify the other of the 3D image data or 2D image data.

20. A method for checking objects that comprises that:
the 3D image data and the 2D image data are transmitted to an evaluation module by at least one camera module having a 3D image sensor for generating 3D image data and a 2D camera for generating 2D image data, and
an object captured by the camera module is classified by means of the evaluation module based on the 3D image data and the 2D image data.

21. A logistics system for checking conveyed objects, comprising:
a system; and
a conveying unit for transporting the conveyed objects, said system comprising:
at least one camera module for capturing an object and an evaluation module, wherein the camera module comprises a 3D image sensor for generating 3D image data and a 2D camera for generating 2D image data, wherein the camera module is configured to transmit the 3D image data and the 2D image data to the evaluation module,
wherein the evaluation module is configured to classify an object captured by the camera module based on the 3D image data and the 2D image data.

22. The logistics system according to claim 21, wherein the conveying unit is configured for use in airports.

23. The logistics system according to claim 21, further comprising:
at least one reader for machine readable codes and/or at least one RFID reader.
